(19) United States
(12) Patent Application Publication
(10) Pub. No.: US 2003/0069763 A1
(43) Pub. Date: Apr. 10, 2003

(54) Business method and system for communicating public-facility status information through a virtual ticket device

(75) Inventors: Laurie E. Gathman, East Norwich, NY (US); Jack E. Haken, Danbury, CT (US)

Correspondence Address: Corporate Patent Counsel, Philips Electronics North America Corporation, 580 White Plains Road, Tarrytown, NY, 10591, US

(73) Assignee: KONINKLIJKE PHILIPS ELECTRONICS N.V.

(21) Appl. No.: 09/971,141

(22) Filed: Oct. 4, 2001

(51) Int. Cl. G06F 17/60

(52) U.S. Cl. 705/5

(57) ABSTRACT

A business method and system for providing status information to patrons of a public facility through patron virtual ticket devices. A message database stores standard and customized information messages. The information messages may be sent on request, at predetermined times, or upon the occurrence of a preselected event.

### CROSS-REFERENCE TO RELATED APPLICATIONS

The present invention is related to those disclosed in the following U.S. patent applications:

1. Ser. No. ______ [Docket No. US 010493], filed concurrently herewith, entitled “SELLING BEST AVAILABLE SEATS AT A PUBLIC FACILITY”;

2. Ser. No. ______ [Docket No. US 010494], filed concurrently herewith, entitled “SYSTEM FOR DISPLAYING PERSONAL MESSAGES AT A PUBLIC FACILITY AND METHOD OF DOING BUSINESS”;

3. Ser. No. ______ [Docket No. US 010495], filed concurrently herewith, entitled “SYSTEM AND BUSINESS FOR OFFERING SEAT UPGRADES TO PATRONS AT A PUBLIC FACILITY”;

4. Ser. No. ______ [Docket No. US 010497), filed concurrently herewith, entitled “TICKET EXCHANGE SYSTEM AND METHOD OF OPERATION”;

5. Ser. No. ______ [Docket No. US 010498], filed concurrently herewith, entitled “PUBLIC VENUE AUCTION SYSTEM AND METHOD OF OPERATION”;

6. Ser. No. ______ [Docket No. US 010499], filed concurrently herewith, entitled “SYSTEM AND METHOD FOR SELLING GOODS TO CUSTOMERS OF A PUBLIC FACILITY”; and

7. Ser. No. ______ [Docket No. US 010500], filed concurrently herewith, entitled “SYSTEM AND METHOD FOR SELLING IMAGE DISPLAY TIME TO CUSTOMERS OF A PUBLIC FACILITY”.

The above applications are commonly assigned to the assignee of the present invention. The disclosures of these related patent applications are hereby incorporated by reference for all purposes as if fully set forth herein.

### TECHNICAL FIELD OF THE INVENTION

The present invention is directed to electronic-ticket control systems and, more specifically, to a method and system for making public-facility status information available by dissemination through a virtual ticket device.

### BACKGROUND OF THE INVENTION

Large public entertainment facilities, such as convention centers, concert halls, stadiums, sports arenas, and the like, are the civic centers of many communities and are important sources of revenue and employment. Quite often, public facilities are funded by taxpayers in order to attract or at least retain sports franchises, and to attract tourists and conventions. The large sums invested in public entertainment facilities make it essential to maximize the revenue derived from such facilities and to minimize their operating costs.

In the process of maximizing their attractiveness, however, large public facilities tend to become very labor-intensive operations. A typical modern sports facility requires a large number of gate attendants, ticket agents, ushers, concession stand operators, shop vendors, and security officers, and the like. Many new sports facilities also employ waiters and waitresses who take orders from, and serve food and drink to, customers at their seats. Facility operators use labor-saving technology wherever possible in order to reduce the high labor costs associated with large public facilities.

The principle sources of revenues for a facility operator are ticket sales, concession stands, and vendor shops. In addition to cutting costs, facility operators also try to increase the revenue from these sources in many different ways. Promotions, for example, are frequently offered in order to increase sales. Many public facilities do not permit patrons to bring their own food and drink into the venues in order to increase sales through concession stands.

In addition, facility operators are increasingly seeking new ways and new technology to provide new and enjoyable services to customers and thereby increase attendance and revenue.

One way to increase attendance is simply to locate in heavily-populated metropolitan areas. This trend in itself has contributed to significantly larger audiences for a single game, concert, or stage play, and necessitated the erection of correspondingly larger facilities. Also driving the construction of ever-larger facilities is a patron base that is increasingly financially well-off. Most patrons, for example, now have their own automobiles that have to be parked nearby, and a larger discretionary budget with which the purchase souvenirs, food and beverages, and even ancillary entertainment (such as batting cages for fans at baseball games). The size of public entertainment facilities is ever-increasing to accommodate not only larger crowds, but to provide them with an ever-greater number of amenities.

Another means of increasing attendance is to expand the segment of the population that forms a base of regular patrons. Almost all forums for entertainment now encourage attendance by entire families, including young children. An attempt is also made to attract visitors whose patronage may include very few, or even single visits such as tourists from foreign countries or other out-of-town guests whose attendance may be part of a larger travel package.

One effect of these efforts is a need to provide facilities that are not only large, but also accessible to patrons who are not regular attendees at either the particular facility in question or even at similar facilities in other locales. One of the best ways to increase accessibility is through the continual and thoughtful dissemination of facility to attending patrons. One way to do this is through increased signage. More signs, larger signs, and signs in multiple languages help make the facility more accessible—that is, easier to enjoy—for a larger number of attendees. There is a limit, however, to the usefulness of facility signs. This is due largely to the fact that a patron has to be present at the sign in order to read it.

There is therefore a need in the art for technical improvements that provide an inviting atmosphere and practical convenience to crowds of ever-increasing size, while at the same time address the need to reduce the costs of operating large public entertainment facilities. For example, there is a need for new technologies that help to disseminate current facility status information to the greatest extent possible without increasing the labor costs associated with a operating large public facilities. Additionally, there is a need for technical improvements that enhance the revenues of large public facilities in order to cover the increasing cost of providing the entertainment itself.

### SUMMARY OF THE INVENTION

To address the above-discussed deficiencies of the prior art, it is a primary object of the present invention to provide a public-facility information guide operable through a virtual ticket device to disseminate timely information in a useful manner. Note that a virtual ticket device is basically a portable computer system that accepts and retains virtual tickets for sports events, theater, concerts, and the like, together with various services and methods of doing business which are linked to and implemented through the virtual ticket device.

In its simplest form, the virtual ticket device is an existing smart telephone or cellular communication-enabled personal digital assistant (PDA), such as a PALM PILOT™ or a VISOR™ electronic organizer. A dedicated virtual ticket device could also be used. A customer who wishes to attend an event purchases admission in any conventional manner (e.g., by telephone from a ticket service, in person at a box office, via the Internet). The ticket vendor sends an encrypted admission authorization record over a wireless channel or a wireline channel to the virtual ticket device, where it is stored as a virtual electronic ticket.

It will be recognized that the virtual ticket device serves multiple functions to its user. There are clear synergies between many of these functions; for example the communications functions of the device may be enhanced when the customer's seat location and entry time are known and stored in the system. Nevertheless many aspects of the present invention remain new and useful even when the customer is admitted to the facility with a paper ticket or in another conventional manner and for this reason, the term “virtual ticket device” as used in this patent specification and the claims which follow, is not limited or restricted to a device which is actually used or even programmed to authorize a customer's admission to the facility.

The encrypted admission authorization record may include, for example, information which identifies the date and location of the event, the seat number, price paid, and the like. The encrypted admission authorization record also may include uniquely encrypted information which may be used in a conventional manner to authenticate that the record is genuine. The same information is preferably stored in a central database which is accessible by the event operator or a service provider. The record in the database should preferably also include the telephone number or wireless address of the virtual ticket device so that contact with the virtual ticket device may be established at a later time.

Entry point terminals are provided at the entrances of the public entertainment facility which read at least the encrypted authentication information from the virtual ticket device and authorize the customer to enter the event. The entry point terminals read the authentication information over a very short range wireless (RF) channel or infrared (IR) channel, or via a dedicated interface slot coupled to a wireline channel to prevent eavesdropping and spoofing of the process. For example, the virtual ticket device may be programmed to display the data either as a string of characters (e.g., serial number) or a bar code on its LCD display and the displayed information can be optically scanned in a chamber of the entry point terminal.

Preferably, both the virtual ticket device and the arena or theater is also equipped with hardware and software which can track the location of the virtual ticket device in and around the entertainment facility with a precision of perhaps a few meters. Once the customer has purchased a virtual ticket, the virtual ticket device can be used, in conjunction with information stored in the central database to provide a number of distinct information and marketing services to the customer.

In one embodiment, the present invention includes a message database for storing standard and custom informational messages and a processor for determining, under the direction of an information control program, the intended recipient or recipients of an informational message and the time at which it should be sent. A status collector (either automatic or manual) for collecting dynamic-status information relating to the public facility, such as gift-shop or restroom congestion, public-safety emergencies, or lost-child information, may also be present. Current status information may also include the current location of public-facility personnel such as security, medical, or customer-service officers (whose locations may be tracked in a manner similar to tracking virtual ticket devices).

In these embodiments, the invention further includes a current-status database for storing collected status information, and a transceiver that can receive, interpret, and respond to requests for information from a virtual ticket device. Status information may also, in some cases, be sent by the transceiver to one or more virtual ticket devices.

### BRIEF DESCRIPTION OF THE DRAWINGS

FIG. 1 is a plan diagram of an entertainment venue in which an electronic ticket control system according to the principles of the present invention may be deployed;

FIG. 2 illustrates an exemplary virtual ticket device which is capable of interacting with an electronic ticket control system according to the principles of the present invention;

FIG. 3 illustrates an exemplary electronic virtual ticket displayed on the virtual ticket device in FIG. 2 according to one embodiment of the present invention;

FIG. 4 illustrates an electronic ticket control system according to one embodiment of the present invention; and

FIG. 5 is a flow diagram illustrating the operation of the electronic ticket control system and the virtual ticket device according to one embodiment of the present invention.

FIG. 6 illustrates selected portions of electronic ticket (eticket) control system that disseminates facility information to patrons of exemplary public facility according to one embodiment of the present invention.

FIG. 7 depicts a flow diagram, which illustrates the operation of electronic ticket control system and portable virtual ticket device according to another embodiment of the present invention.

### DETAILED DESCRIPTION OF THE INVENTION

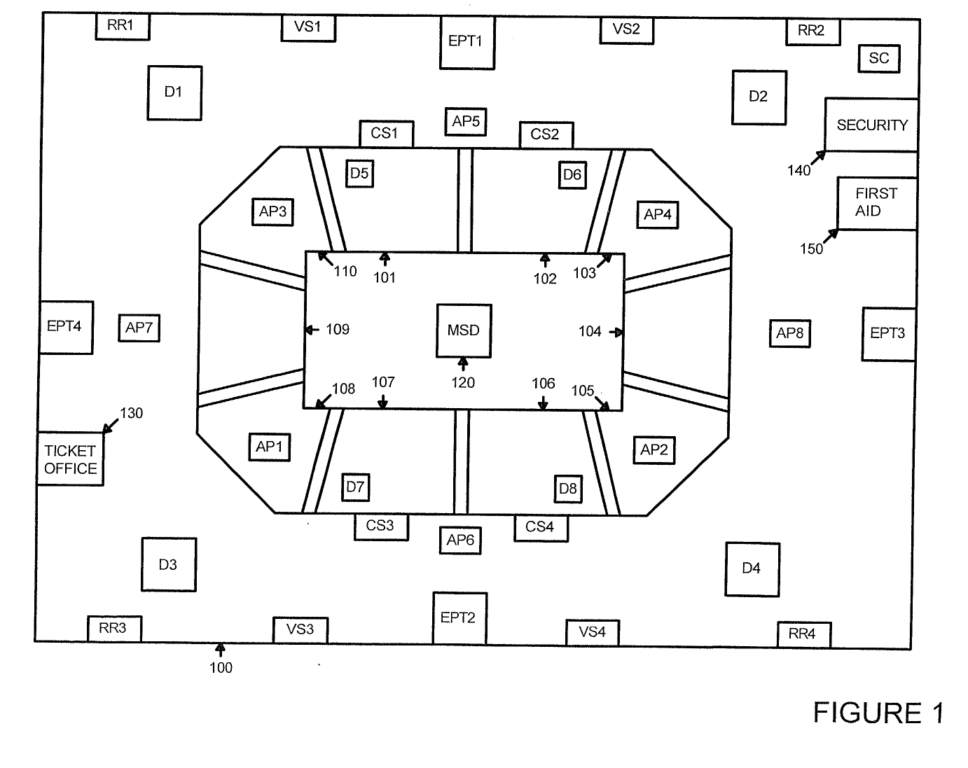

FIGS. 1 through 7, discussed below, and the various embodiments used to describe the principles of the present invention in this patent document are by way of illustration only and should not be construed in any way to limit the scope of the invention. Those skilled in the art will understand that the principles of the present invention may be implemented in any suitably arranged hand-held electronic organizer, personal digital assistant, or advanced mobile telephone.

FIG. 1 is a plan view of public facility 100 in which an electronic ticket (eticket) control system according to the principles of the present invention may be deployed. Public facility 100 is representative of any public venue that is capable of holding a large audience. Thus, public facility 100 may include a football or baseball stadium, a basketball or hockey arena, a large concert hall, a convention center, and the like. As used herein and for the purpose of determining the scope of the claims of the present invention, the term “public facility” may include any controlled-access location to which people may be admitted by means of an electronic ticket control system and should not be construed to exclude facilities that are privately owned or that are open only to selected portions of the general public. In fact, public facility 100 may include controlled-access private clubs and private buildings, and even controlled-access forms of transportation, such as trains, planes, cruise ships, and the like. However, for the purpose of simplicity in explaining the principles of the present invention, it shall generally be assumed that public facility 100 is a sports facility.

Public facility 100 comprises a plurality of seating areas, including exemplary seat sections 101-110, that surround a playing area (e.g, hockey rink, basketball court, indoor track, or the like).

Suspended over the playing area is multi-sided display (MSD) 120, which has large display screens on four sides. The seating areas are surrounded by an exterior promenade area that contains a plurality of concession stands (CS), including four exemplary concession stands labeled CS1, CS2, CS3 and CS4. The promenade area also includes a number of rest rooms (RR), including exemplary rest rooms labeled RR1, RR2, RR3 and RR4, and numerous vendor shops (VS), including exemplary vendor shops labeled VS1, VS2, VS3 and VS4. Finally, the promenade area contains ticket office 130, security office 140, and first aid station 150. A parking facility (not shown), such as a lot, garage, or valet-assisted parking system, may also be associated with public facility 100.

Electronic displays of various types are positioned throughout public facility 100. In the promenade area, displays D1, D2, D3 and D4 enable patrons at the concession stands or vendor shops, or waiting in rest room lines, to view the sporting event that is ongoing in the playing area. In the seating area, patrons can view displays D5, D6, D7 and D8, which typically display advertisements, scores of other sporting events, player statistics, audience greetings, and the like.

As used herein and for the purpose of determining the scope of the claims of the present invention, displays D1-D8 may be any type of conventional display devices, including electronic signs, conventional sized television sets, large screen television sets, and multisided television displays, that generally may be viewed by at least some of the customers of public facility 100 and do not include non-public displays which are viewed by employees of public facility 100.

For example, each one of displays D1, D2, D3 and D4 may be an elevated multisided display system having three or four sides, wherein each side contains a large screen video display. Also, in an exemplary embodiment, one or more of displays D5-D8 in the seating area may be a conventional television set that is disposed in a luxury box of public facility 100.

Each of entry point terminals EPT1, EPT2, EPT3 and EPT4 is disposed next to one of four entrances to public facility 100. EPT1, EPT2, EPT3 and EPT4 are capable of detecting and registering the virtual electronic tickets used by customers of public facility 100.

EPT1-EPT4 read at least the encrypted authentication information from the virtual ticket device and authorize the customer to enter public facility 100. Each one of EPT1, EPT2, EPT3 and EPT4 registers the admission of each virtual electronic ticket by any one of several conventional technologies. For example, one or more of EPT1, EPT2, EPT3 and EPT4 may comprise an optical scanner that scans a bar code or a serial, number displayed on the display of a virtual ticket device that stores each virtual electronic ticket. Alternatively, one or more of EPT1, EPT2, EPT3 and EPT4 may comprise a radio frequency transceiver that establishes an RF link (such as a Bluetooth connection), or an infrared (IR) transceiver that establishes an IR link, that transfers the virtual electronic ticket information from the virtual ticket device used by the customer to the entry point terminal. In still another embodiment, one or more of EPT1, EPT2, EPT3 and EPT4 may contain a slot or a similar hardware interface into which a virtual ticket device may be inserted or engaged in order to transfer the virtual electronic ticket information via a wireline connection.

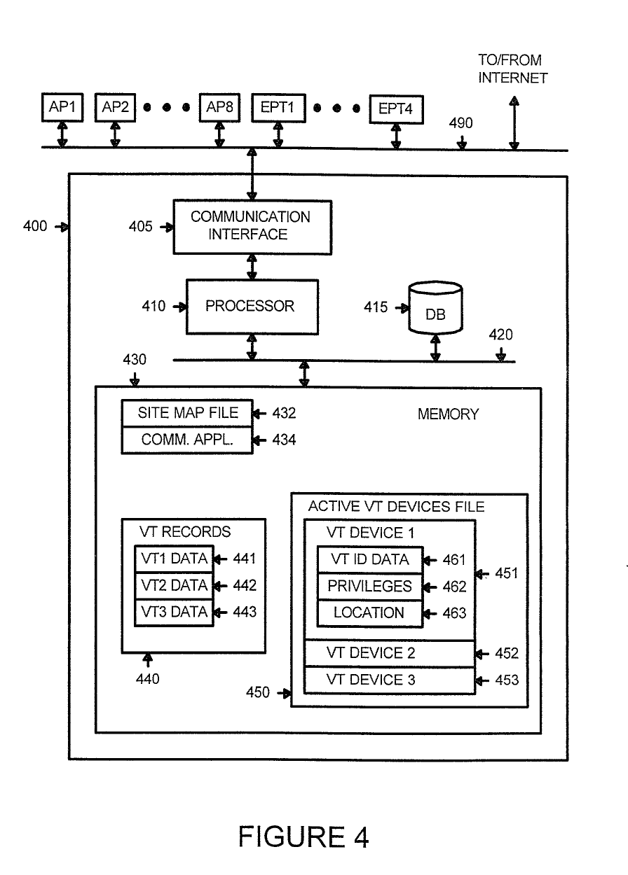

In accordance with the present invention, one or more status collectors (SC) may also be present. A status collector is an automatic or partially automatic information gathering device that monitors current conditions and transmits status reports to the electronic ticket control system (see FIG. 4). The information may concern, for example, crowd-density information, such as at restrooms, concession stands, or parking lots. As an example of automatic operation, a video camera could view concession stand areas and an associated image-analysis program could analyze the captured image to estimate crowd density. In a partially automatic scenario, concession stand attendants may be prompted periodically to manually input crowd-density estimates. Another example of a status monitor track the rate of movement, for example of people going out of a restroom or of cars leaving the parking lot, in order to estimate how busy those facilities are. The current status information is stored for later use in reporting to patrons, as more fully desired below.

Additionally, a number of wireless or wireline access points (APs) are distributed throughout the seating area and the promenade area of public facility 100. Exemplary access points labeled AP1-AP8 are shown in FIG. 1. According to an advantageous embodiment of the present invention, EPT1-EPT4 may function both as access points and as entry point terminals. AP1-AP8 provide communication channels that permit the virtual ticket devices used by customers to communicate with the electronic ticket control system associated with public facility 100. According to an advantageous embodiment of the present invention, AP1-AP8 are radio frequency transceivers similar to the base stations of a cellular telephone system that provide two-way radio frequency (RF) communication links with virtual ticket devices within public facility 100. Preferably, AP1-AP8 have a hand-off capability that allows a customer to roam throughout public facility 100 without losing communication with the electronic ticket control system. Advantageously, this allows the electronic ticket control system to continually track the location of each virtual ticket device in public facility 100.

However, in an alternate embodiment of the present invention, one or more of AP1-AP8 may be physical interface slots into which virtual tickets devices may be inserted. For example, each seat in public facility 100 may be provided with an interface slot (similar to an electronic cradle) that may mate with a virtual ticket device. A wireline connection to each such interface slot enables each virtual ticket device to communicate with the electronic ticket control system. Furthermore, according to an advantageous embodiment of the present invention, exterior access points (not shown) may be disposed in the areas outside of public facility 100 in order to communicate with customers as they are, for example, in a parking garage. That is, even before they enter public facility 100.

Access points, such as AP1-AP8 and EPT1-EPT4, may be used to provide a variety of user-friendly services to the patrons of public facility 100. When a customer is near, but not yet admitted to, public facility 100, the access points may transmit useful information to the virtual ticket device used by the customer, including directions to the nearest entrance, advice as to which entrance has the shortest waiting line, promotional items available at vendor shops and concession stands, and the like. Parking-lot access points can be used to receive and record the location of a parked car for later reference by the patron after the event is over. After the customer has been admitted to public facility 100, the access points may provide the virtual ticket device real-time directions from her present location to her assigned seat, to particular concession stands or vendor shops, to rest rooms, or to other service areas. Information on which concession and service has the shortest line can also be provided.

In one embodiment, a standard or customized dialogue (series of messages that may include patron responses or requests) may be initiated when a patron first comes within range of a facility access point. The dialogue may be initiated by either the patron or automatically by the electronic ticket control system. For example, a customer in the parking lot exits a car and turns on the virtual ticket device, which automatically searches for an access point. Or, if the virtual ticket device is a standard PDA or mobile phone, which may already be on, the dialogue may be initiated by patron entry of a code or by a patron device response to a polling signal. The dialogue begins, for example, when the virtual ticket device receives a communication confirming its location in the parking lot, which it may also later display automatically as the patron exits the facility. The electronic ticket control system then receives a message indicating the identity of the patron (or, more precisely, of the virtual ticket device) and adjusts the dialogue depending on whether the patron is a local resident or out-of-town visitor. The patron receives confirmation of how many electronic tickets are held for the particular event, or gives instructions to proceed to the ticket or “will call” window as appropriate. The patron is then updated on the start time or current status of the event and may be given the opportunity to place an initial food or beverage order that may be picked up or delivered once the patron actually enters the facility.

The dialogue may continue throughout the patron's visit or may be terminated or limited by the patron.

Using the access points, the facility operator can determine in real time how many admitted customers are at their seats and may schedule the start of programs on this basis. The customer can place orders for food and promotional items via the access points using the virtual ticket device and the vendors can deliver these goods to a present or designated location. The access points and the virtual ticket device can also be used to authenticate the identity of the customer before the goods are turned over to her.

The facility operator may use the access points to communicate information to the virtual ticket devices about available seating upgrades. These could be based on the real time location of the customer. For example, an access point may transmit to the virtual ticket device the message: “Two seats are available in the section in front of you. Would you like to move there for an additional $10?” If the virtual ticket device has capability for broadband communication and a reasonably high quality display, this could be supplemented with video promotions, such as: “Here's what the last home run looked like from section 110. Would you like to upgrade your seat and move there?”

Customers can use their virtual ticket devices to signal their present location within public facility 100 to friends and to locate lost family members. Such information may be especially helpful, for example, in locating a lost child or indicating the location of a patron needing medical attention. A network of entry point terminals may be used within public facility 100 to authorize admission to various areas such as preferred seating sections, clubs, luxury boxes, reserved rest rooms, priority parking lots, and the like.

Additionally, automated cameras in public facility 100 may be used to photograph the customers during an event and the photographs can later be identified with groups of virtual tickets and offered for sale to the customers. In the case of accidents or disruptions, the location information can be used to contact potential witnesses. Additionally, seating and purchase information can be used for directed post-event marketing, which can be communicated directly to the virtual ticket device.

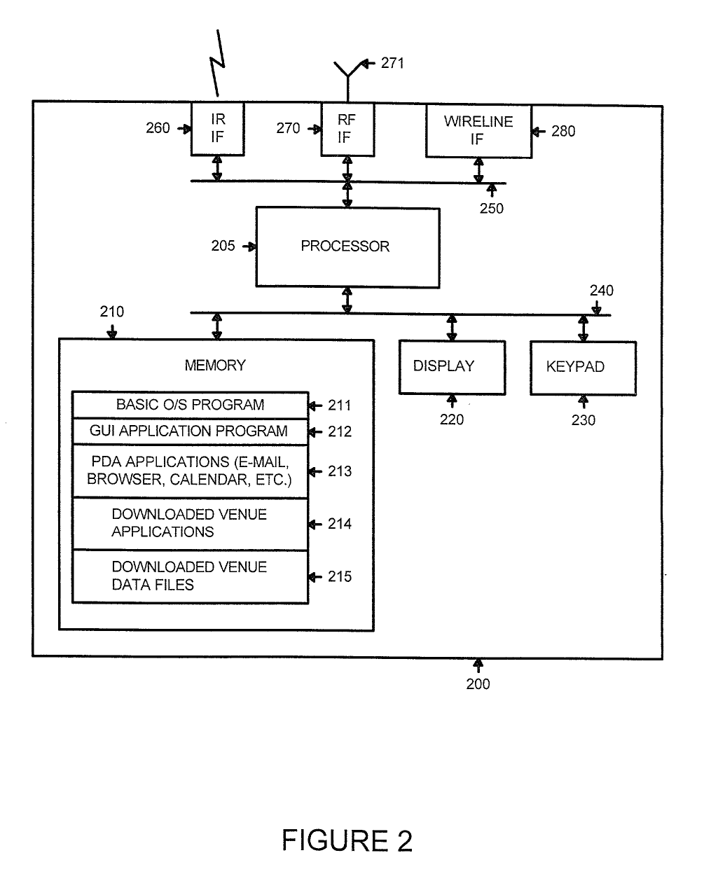

FIG. 2 illustrates virtual ticket device 200, which is capable of interacting with an eticket control system according to the principles of the present invention. Virtual ticket device 200 comprises processor 205, memory 210, display 220, keypad 230, and one or more communication interfaces (IFs), including infrared (IR) interface 260, radio frequency (RF) interface 270, and wireline interface 280. Processor 205, memory 210, display 220, and keypad 230 are coupled to, and communicate via, system bus 240. Processor 205, memory 210, display 220, and keypad 230 are coupled to, and communicate via, input/output (I/O) bus 250.

Processor 205 controls the overall operation of virtual ticket device 200 by executing basic operating system (O/S) program 211 in memory 210. Memory 210 also stores graphical user interface (GUI) application program 212, a plurality of personal digital assistant (PDA) applications 213, downloaded venue applications 214, and downloaded venue data files 215. PDA applications 213 may include, for example, an e-mail application, a browser application, a calendar application, and the like.

In the illustrated embodiment, virtual ticket device 200 contains three external communication interfaces, namely, IR interface 260, RF interface 270, and wireline interface 280. However, not all of these external communication interfaces are necessary to the operation of the invention. For example, in an advantageous embodiment of the present invention, virtual ticket device 200 may only contain wireline interface 280 and RF interface 270. Virtual ticket device 200 may be adapted for insertion into a cradle device that plugs into wireline interface 280 and provides virtual ticket device 200 with electrical power for recharging a battery (not shown) in virtual ticket device 200. When virtual ticket device 200 is plugged into a cradle device, applications and data may be downloaded or uploaded via wireline interface 280.

For example, in an advantageous embodiment of the present invention, virtual ticket device 200 may be a wireless enabled electronic organizer, such as a Palm VII™ organizer. As those skilled in the art are aware, a Palm VII™ organizer (or an equivalent appliance) is capable of communicating via a wireless interface (such as RF interface 270) and may be mounted in a cradle device that provides wireline communication and power supply voltages to the organizer.

Processor 205 executes GUI application program 212 in order to interact with the operator of virtual ticket device 200 via keypad 230 and display 220. Normally, GUI application program 212 enables processor 205 to execute PDA applications 213 stored in memory 210.

One of these applications may include a browser application that allows virtual ticket device 200 to access via RF interface 270 or wireline interface 280 a website for a ticket agency in order to purchase a virtual electronic ticket to an event at public facility 100. When a virtual electronic ticket is purchased in this manner, the virtual electronic ticket and other useful applications and data files may be downloaded from the ticket agency website to virtual ticket device 200 and stored in downloaded venue applications 214 and downloaded venue data file 215.

Downloaded venue data file 215 may be used to store such information as the virtual electronic ticket, electronic maps of public facility 100, text information related to concession stands and vendor shops, and text information related to security and first aid at public facility 100. Downloaded venue applications 214 may include one or more applications executed by processor 205 when the customer is at public facility 100. In particular, downloaded venue applications 214 may include a communication application that enables processor 205 to control the operation of RF interface 270 and wireline interface 280 such that virtual ticket device 200 is capable of communicating with access points AP1-AP8 and entry point terminals EPT1-EPT4 at public facility 100. For example, the communication application may configure RF interface 270 in virtual ticket device 200 to use the operating frequency channels and medium access control (MAC) layer protocols used by AP1-AP8 and EPT1-EPT4.

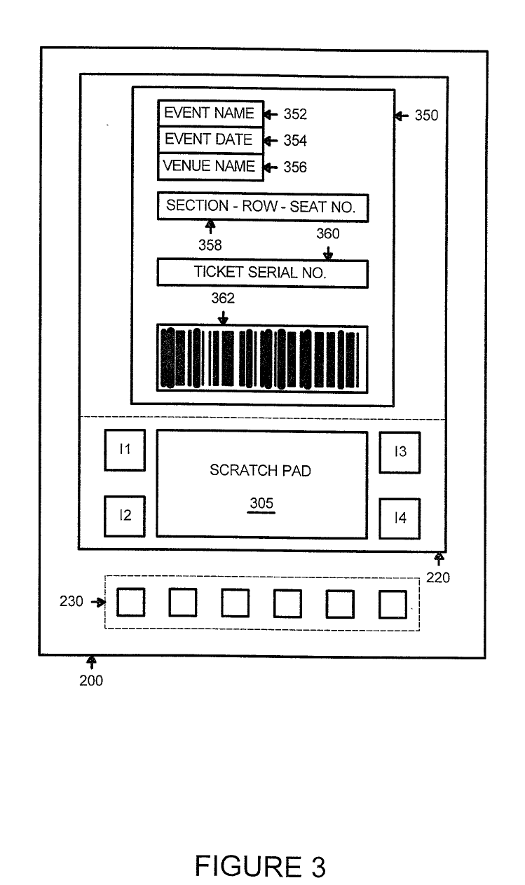

FIG. 3 illustrates virtual electronic ticket 350 displayed on virtual ticket device (VTD) 200 according to one embodiment of the present invention. Virtual ticket device 200 comprises display 220, and keypad 230. The lower portion of display 220 contains scratch pad 305 and a plurality of icons, namely icons I1, I2, I3, and I4. The upper portion of display 220 contains virtual electronic ticket 350. Virtual electronic ticket 350 comprises event name field 352, event date field 354, venue name field 356, seating information field 358, ticket serial number field 360, and bar code field 362. Display 220 may also be used to display information and status messages transmitted according to an embodiment of the present invention.

The operator of virtual ticket device 200 may use a stylus or a similar device to select icons I1, I2, I3 or I4 and thereby launch one or more of PDA applications 213 in memory 210. Additionally, the operator may use the stylus to enter text or numbers in scratch pad area 305 when executing one of PDA applications 213 that permits the entry of text data. Additionally, the buttons in keypad 230 may be used to select icons or to perform functions such as scroll up, scroll down, scroll left, scroll right and the like. Any of these user-input devices may also be used to request specific information from electronic ticket control system, or to respond to messages already received.

When the customer approaches or enters public facility 100, the customer turns on virtual ticket device 200 and launches the communication application in downloaded venue applications 214 that allows virtual ticket device 200 to communicate with entry point terminals EPT1-EPT4 and access points AP1-AP8 in public facility 100.

The communication application may be launched automatically simply by selecting virtual electronic ticket 350 that has been downloaded and stored in downloaded venue data files 215. Event name field 352 contains the name of the event occurring in public facility 100, such as “New York Knicks vs. Indiana Pacers.” Event date field 354 contains the date on which the event is occurring, such as “Nov. 13, 2001.” Venue name field 356 contains the name of public facility 100, such as “Madison Square Garden.” Seating information field 358 contains the section, row, and seat number information associated with virtual electronic ticket 350.

If the entry point terminal contain an optical scanner, the optical scanner may scan one or both of ticket serial number field 360 and bar code field 362. An optical character recognition application may be used to read the serial number appearing in ticket serial number field 360. A conventional bar code scanner device may read the bar code in bar code field 362. In either event, when virtual electronic ticket 350 is identified, the entry point terminal accesses the data base associated with the electronic ticket control system associated with public facility 100 and, if virtual electronic ticket 350 is properly authenticated, permits the customer to enter public facility 100. The entry point terminal may produce a visible or audible signal approving entry by the customer. Alternatively, if virtual electronic ticket 350 is not authenticated, the entry point terminal may generate an audible or visual alarm alerting a nearby gate attendant that the customer should not be admitted to public facility 100.

FIG. 4 illustrates electronic ticket control system (ETCs) 400 according to one embodiment of the present invention. Electronic ticket control system 400 comprises communication interface 405, processor 410, database (DB) 415, and memory 430. Processor 410, database (DB) 415, and memory 430 are coupled to, and communicate via system bus 420. Communication interface 405 has an external network connection that interfaces with network bus 490. Communication interface 405 enables processor 410 to communicate with exemplary access points AP1-AP8 and exemplary entry point terminals EPT1-EPT4.

Communication interface 405 also enables processor 410 to communicate with remote servers and other devices via the Internet.

Memory 430 stores site map file 432, communication application program 434, virtual ticket records 440, and active virtual ticket devices file 450. Virtual ticket records 440 contains a plurality of virtual ticket data records 441-443, which are arbitrarily labeled VT1 DATA, VT2 DATA and VT3 DATA, respectively. Virtual ticket records 440 comprises a master list of all virtual tickets that were sold to the particular event occurring at public facility 100. Each virtual ticket data record 441-443 contains the serial number or bar code of each virtual ticket, the section and seat number information associated with each virtual ticket, payment information (optionally), the privileges associated with each virtual ticket, and the like. The virtual tickets that are received from the virtual ticket devices are compared to the virtual ticket data in virtual ticket records 440 before admitting each customer to public facility 100.

Virtual ticket data records 441-443 may be downloaded via the Internet from a server associated with a ticketing agency that sells tickets to events held at public facility 100. Alternatively, electronic ticket control system 400 itself also may function as a server that potential customers may access over the Internet in order to buy virtual tickets. As each virtual ticket is sold to a potential customer, electronic ticket control system 400 creates and stores a corresponding virtual ticket data record 441 and transmits the electronic virtual ticket over the Internet to the customer.

Active virtual ticket devices file 450 contains virtual ticket device records 451-453 associated with virtual ticket devices that are in active communication with electronic ticket control system 400. After each received virtual ticket is received and authenticated, a virtual ticket device record for the corresponding virtual ticket device that has been admitted is created in active virtual ticket device file 450. Virtual ticket device records 451-453 are arbitrarily labeled VT DEVICE 1, VT DEVICE 2, and VT DEVICE 3, respectively. Exemplary virtual ticket device record 451 comprises virtual ticket (VT) identification (ID) data field 461, privileges field 462, and location field 463. Database 415 normally holds the master copies of all of the information stored in memory 430. However, the information in database 415 is loaded into memory 430 for processing by processor 410.

Site map file 432 contains electronic map data that may be downloaded to virtual ticket device 200 in order to display the location of the seat corresponding to a particular virtual ticket. The electronic map data also may illustrate the locations of the rest rooms, concession stands, vendor shops, ticket office 130, security office 140 and first aid station 150. Virtual ticket identification field 461 identifies the virtual ticket associated with virtual ticket device record 451. Privileges field 462 indicates the restricted areas in public facility 100 to which the virtual ticket gains admission. For example, privileges field 462 may indicate which restaurants and luxury boxes the user of a particular virtual ticket may enter. Finally, location field 463 indicates the current location of virtual ticket device 200.

Communication application program 434 comprises a communication protocol that may be transmitted to virtual ticket device 200 in order to permit virtual ticket device 200 to communicate with the access points and entry point terminals in public facility 100. According to one embodiment of the present invention, a user of virtual ticket device 200 may download communication application program 434 from electronic ticket control system 400 via the Internet before going to public facility 200. Alternatively, electronic ticket control system 400 may initially use a standard protocol to establish a simple connection with virtual ticket device 200 and then may download communication application 434 is order to establish a more advanced communication link.

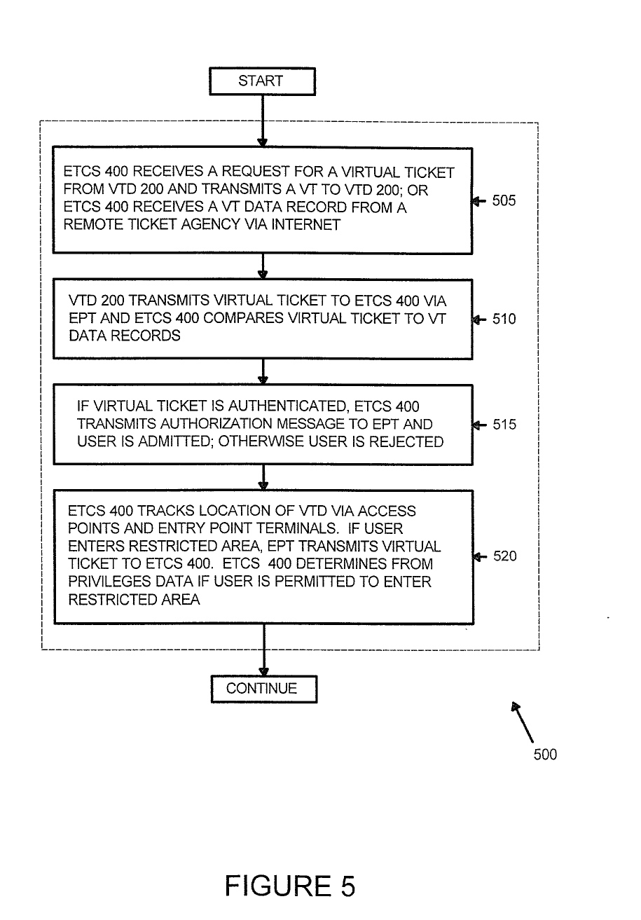

For example, if EPT1 and virtual ticket device 200 are both Bluetooth-enabled systems, EPT1 may establish an initial Bluetooth connection with virtual ticket device 200 as the user of virtual ticket device 200 approaches EPT1. After the Bluetooth connection is established, EPT1 may download communication application program 434 to virtual ticket device 200. Thereafter, virtual ticket device 200 may use communication application program 434 to establish wireless LAN (e.g., IEEE 802.11) connections with one or more of EPT1-EPT4 and AP1-AP8 as the user of virtual ticket device 200 roams around public facility 100. FIG. 5 depicts flow diagram 500, which illustrates the operation of electronic ticket control system 400 and portable virtual ticket device 200 according to one embodiment of the present invention. Initially, electronic ticket control system 400 receives a request for a virtual ticket from virtual ticket device 200. This request may be received via the Internet or via a telephone connection. In response, electronic ticket control system 400 transmits a virtual ticket to virtual ticket device 200. Alternatively, electronic ticket control system 400 may receive a virtual ticket data record for an already issued ticket from a remote ticket agency via the Internet (process step 505).

When the user finally arrives at public facility 100 to attend the event, virtual ticket device 200 transmits the virtual ticket stored in the virtual ticket device 200 to electronic ticket control system 400 via an entry point terminal. Electronic ticket control system 400 then compares the virtual ticket to the virtual ticket data records 440 stored in memory 430 or database 415 (process step 510).

If the virtual ticket is authenticated, electronic ticket control system 400 transmits an authorization message to the entry point terminal and the user is admitted. Otherwise, the user is rejected (process step 515).

During the event, electronic ticket control system 400 may track the location of virtual ticket device 200 via the numerous access points and entry point terminals. If the user attempts to enter a restricted area, such as a private restaurant, a luxury box, or a premium seating area, the entry point terminal at the restricted area transmits the virtual ticket to electronic ticket control system 400.

Electronic ticket control system 400 determines from the privileges data whether or not the user is permitted to enter the restricted area (process step 520).

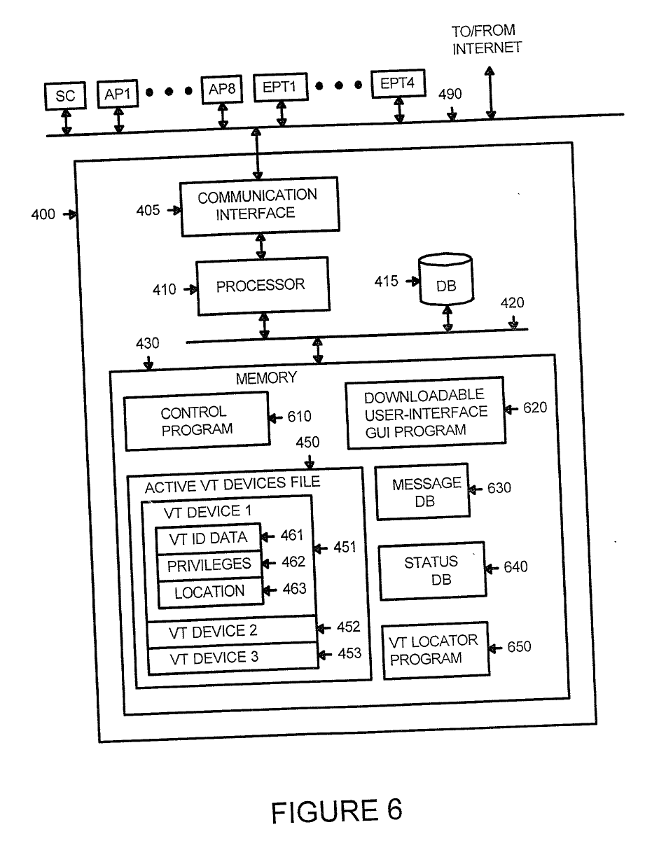

FIG. 6 illustrates selected portions of electronic ticket control system 400 that disseminates facility information to patrons of the exemplary public facility 100 according to one embodiment of the present invention. In addition to the components illustrated in FIG. 4 and described above, electronic ticket control system 400 also comprises a plurality of application programs and data files stored in memory 430 that enable electronic ticket control system 400 to communicate with virtual ticket devices in order to selectively disseminate appropriate information. Memory 430 stores control program 610, downloadable user-interface program 620, message database (DB) 630, status database 640, and virtual ticket device locator program 650.

Processor 410 executes program instructions in control program 610 to enable electronic ticket control system 400 to communicate with virtual ticket devices in order to present information and, when included as a feature, to receive results and responses from virtual ticket devices. It was noted in the above description of FIG. 2 that downloaded venue applications 214 in virtual ticket device 200 may include one or more applications executed by virtual ticket device 200 when the customer is at public facility 100. These applications may be downloaded before the customer arrives at public facility 100 (e.g., via the Internet) or may be downloaded at public facility 100 via entry point terminals EPT1-EPT4 or access points AP1-AP8. Downloadable user-interface program 620 is one such downloadable program. User-interface program 620 provides additional user-interface options and features, such as a graphical user interface (GUI) for use on virtual ticket device 200 that enables the user to interact with control program 610.

According to an exemplary embodiment of the present invention, the user-interface program 620 may be similar to an e-mail application or to a two-way paging application. In an alternate embodiment of the present invention, the user-interface program 620 may be similar to a browser application in that may be transmitted as HTML data and displayed in a web page format on virtual ticket device 200. User-interface program 620 permits the virtual ticket device 200, for example, to selectively display unsolicited information, to request specific information, to scroll through a menu of information-related options, or to redisplay previously sent information. Message database 630 may also store picture files (e.g., JPEG, BMP, GIF) so that information may be presented graphically on virtual ticket device 200. Status database 640 stores current-status information that is provided by one or more status-collectors (see FIG. 1). Current-status information stored in status database 640 may then, when requested, be retrieved and combined with a standard message from message database 630 and transmitted to provide current and useful information when requested. Although for clarity, message database 630 and status database 640 are shown separately, but there is no requirement that they actually reside in separate physical locations.

Control program 610 uses virtual ticket device locator program 650 to determine the location of virtual ticket device 200.

Generally, the location of virtual ticket device 200 may be determined from the section and seat information associated with the virtual ticket of the user. However, assuming the user roams around, the location of virtual ticket device 200 may be determined by transmitting a message to virtual ticket device 200 prompting the user to enter his or her current location (i.e., nearby section and seat values). In still another embodiment of the present invention, virtual ticket device locator program 650 may determine the location of virtual ticket device 200 according to the location of the access point that is in communication with the virtual ticket device. In particular, in more advanced RF systems, virtual ticket device locator program 650 may use triangulation information captured by two or more access points to determine the location of virtual ticket device 200 without requiring any user input. The informational messages sent or made available to a user can then be selected based on the location information (which may be stored for future reference). Likewise, the current location of certain public-facility personnel, for example, security officers, may be determined, stored, and transmitted to patrons needing assistance via their virtual ticket devices.

Message database (DB) 630 retains a collection of standard messages for transmission to patrons as well as current custom messages that have been created, manually or automatically, for a specific purpose. The message are thereby available for transmission at a predetermined time, or upon request. Processor 410, under the direction of control program 610, processes such requests by retrieving and selectively transmitting an appropriate message.

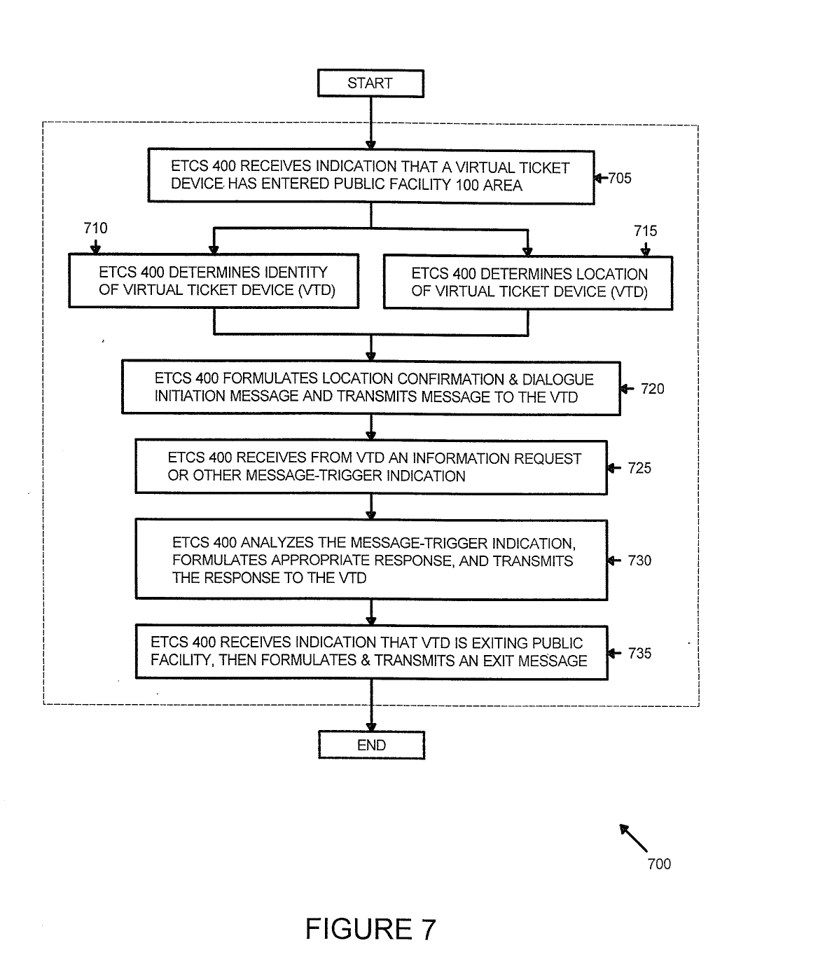

FIG. 7 depicts flow diagram 700, which illustrates the operation of electronic ticket control system 400 and portable virtual ticket device 200 according to another embodiment of the present invention. The process begins when the presence of virtual ticket device 200 is detected at one or more access points associated with public facility 100 (step 705). The electronic ticket control system then determines the identity of virtual ticket device 200 (which may include personal data relating to the patron or may simply include currently held eticket information)(step 710). At the same time, the location of the virtual ticket device 200 is determined with as much precision as possible (step 715). Whether inside or outside the public facility 100, however, this “initial location” information is stored, associated with the identity information, and possibly associated with other information such as time of initiation. At step 720, electronic ticket control system 400 formulates a location confirmation and dialogue initiation message and transmits it to virtual ticket device 200. As used herein, a dialogue is a series of informational messages that preferably, but not necessarily, include patron feedback of some kind. Alternately, the electronic ticket control system 400 may first determine if confirmation and dialogue is appropriate (step not shown). This determination is based on predetermined criteria, which may include such information as where the patron is, whether the virtual ticket device is capable of receiving such messages, and previously selected patron preferences.

If no dialogue is presently to be initiated, the system simply waits until a request for information is received (with respect to that virtual ticket device 200). Assuming dialogue is appropriate, however, an initiation message is sent at step 720. This may be, for example, a generic welcome message, an options menu, or a location confirmation message followed by an option to be reminded later of the patron's initial location.

The dialogue may end with this message or continue on with other pertinent information after the initial dialogue, however, the information guide of the present invention simply waits until electronic ticket control system 400 receives an information request from the virtual ticket device or other message-trigger indication (step 725). Note that this message-trigger may, for example, be a patron request for information, a request from another patron or from the operator of the public facility 100, or automatically generated in electronic ticket control device 400 base on pre-established criteria.

When a message-trigger indication is received, electronic ticket control system 400 analyzes the indication, and formulates and transmits an appropriate response to the virtual ticket device 200 (step 730). The message may go to one or any number of virtual ticket devices. For example, the response to a request for food-order status may go to only one patron, a response indicating some specific tour group should assemble may go to many, and a response (e.g., to an operator request) indicating approaching inclement weather may go to everyone.

The process of receiving and responding to request, of course, may be repeated as often as necessary. In this embodiment, the final such request is at step 735, where the electronic ticket control system 400 receives an indication (i.e., automatically generated message-trigger) that the patron is exiting public facility 100, whereupon it formulates and transmits an exit message such as “Thank you for attending. Remember, you are parked in Section B-6. Have a nice day.”

### SOME EXAMPLES

### Example 1

A customer accesses a menu on her virtual ticket device and requests the location of nearby toilet facilities. The system determines the location of the virtual ticket device and responds by displaying on the virtual ticket device the location of and directions to several nearby ladies rest room facilities and the approximate waiting times to use each facility.

### Example 2

A customer accesses a menu on her virtual ticket device and requests the location of nearby food concessions. The system determines the location of the virtual ticket device and responds by displaying on the virtual ticket device the location of and directions to several nearby food concession facilities and the approximate waiting times to use each facility. The customer decides that the indicated waiting times are too long and from a menu, requests to be notified when waiting ties at a nearby facility are less than five minutes. The system responds with a message to the customer when this condition is met.

### Example 3

The facility operator becomes concerned that high temperatures and humidity in the facility may adversely affect the health of some customers. Messages are selectively addressed to the virtual ticket devices of various groups of customers, eg those sitting in the sun, parents accompanied by young children and or senior citizens, which advise them of locations of first aid stations, free drinking water distribution, concession stands selling hats etc.

### Example 4

Messages are selectively addressed to the virtual ticket devices of customers who are known to reside out-of-town which advise them of nearby facilities which offer souvenirs of the visiting team.

### Example 5

The facility operator notes that waiting times or sales volume at particular food concession or souvenir stands are unusually short. Messages are sent to the virtual ticket devices of customers who are located some distance away from the particular stands which offer special discounts if the customers are willing to walk to the distant stand.

### Example 6

A facility operator uses location information from customer virtual ticket devices to determine the number of admitted customers who have reached their assigned seats. The start of a performance is delayed until the proportion of customers at their seats is above a predetermined threshold. If the proportion does not exceed the threshold at an assigned starting time, messages are selectively sent to the virtual ticket devices of unseated customers which urge them to hurry.

### Example 7

Parents send messages to their children's virtual ticket devices which direct the children either to their assigned seats to the parent's actual location.

What is claimed is:

1. In a public facility in communication with at least one patron through a virtual ticket device (VTD) interface, a method of doing business, comprising:
detecting that a VTD is within communication range of the VTD interface;
determining the identity and location of the detected VTD; and
selectively providing information to the identified VTD on the basis of the determined identity and location.

2. The method of doing business of claim 1, wherein the information provided to the VTD includes a description of the determined location.

3. The method of doing business of claim 1, wherein the public facility maintains a database of estimated waiting times at selected facilities, and wherein the information provided to the VTD includes information relating the estimated waiting time for at least one facility.

4. The method of doing business of claim 3, wherein the request transmitted from the VTD includes a maximum-wait time, and further comprising the step of determining whether the estimated waiting time at the at least one facility is less than the maximum-wait time, and wherein the information relating to the estimated waiting time is sent upon determining that the estimated waiting time is less than the maximum-wait time.

5. The method of doing business of claim 3 wherein the facility is a public toilet.

6. The method of doing business of claim 3 wherein the facility is a concession stand.

7. The method of doing business of claim 6 further comprising the step of claim 6 further comprising the steps of allowing discounts when a holder of the VTD makes purchases at the concession stand and communicating information about the allowed discount to the VTD

8. The method of doing business of claim 3 wherein the facility is an aid station.

9. The method of doing business of claim 1, further comprising the step of storing in memory the determined VTD identity and location.

10. The method of doing business of claim 9, further comprising the steps of:
determining that the VTD has passed an entry point at the public facility;
determining subsequently that the VTD has passed an entry point of the public facility for at least a second time; and
providing automatically to the VTD information including a description of the stored location.

11. The method of doing business of claim 10, wherein a plurality of VTD locations have been stored, and wherein the description automatically provided describes the first stored VTD location.

13. In a public facility including a transceiver for communicating with virtual ticket devices, said facility having at least one status collector, a method of doing business, comprising:
providing a database in communication with the status collector for storing collected status information;
receiving status information for storage in the database;
receiving a request for status information; and
transmitting the requested status information to at least one VTD.

14. The method of doing business of claim 13, wherein the request for status information is received from a VTD.

15. The method of doing business of claim 13, wherein the request for status information is generated automatically.

15. The method of doing business of claim 14, wherein the automatically-generated request is generated upon determining that the VTD has relocated from a first location to a second location.

16. The method of doing business of claim 15, wherein the automatically-generated request is generated upon determining that an event taking place in the public facility has ended.

17. The method of doing business of claim 13, wherein the status collector measures the rate at which vehicles are leaving a parking area associated with the public facility.

18. A public-facility information guide, comprising:
an electronic ticket control system for processing public-facility information in order to formulate information messages;
at least one access point in communication with the electronic ticket control system, the access point being capable of communicating with a public-facility patron virtual ticket device; and
at least one status collector in communication with the electronic ticket control system for collecting and reporting status information.

19. The information guide of claim 18, wherein the status collector collects crowd-density information.

20. The information guide of claim 18, wherein the status collector collects waiting time information.

20. An electronic ticket control system, comprising:
a message database for storing information-message data;
a control program for directing a processor of the electronic ticket control system to formulate an information message using the information message data, wherein the information messages are formulated in response to information requests;
an access point coupled to transmit information messages formulated by the processor to a public-facility patron virtual ticket device; and
a status database for storing status information collected by a status collector, wherein the processor uses the stored status information in formulating information messages.
